(19) United States
(12) Patent Application Publication
(10) Pub. No.: US 2011/0123314 A1
(43) Pub. Date: May 26, 2011

(54) APPARATUS AND METHOD FOR FORCED CONVECTION OF SEAWATER

(76) Inventor: Tyson York Winarski, Tempe, AZ (US)

(21) Appl. No.: 12/623,396

(22) Filed: Nov. 21, 2009

(51) Int. Cl. F03B 13/00; A01G 15/00

(52) U.S. Cl. 415/121.3; 239/14.1

(57) ABSTRACT

An apparatus and method for reducing the temperature of ocean surface waters through one of two pumping methods to pump water between warm surface layers and cold subsurface layers of the ocean. The apparatus includes a seabed anchor, a helical screw rotatably connected to the seabed anchor, a flotation device connected to the helical screw to lift a top portion of the helical screw into a proximal position of a top surface water layer of an ocean, and a motor coupled to the helical screw to rotate the helical screw.

### FIELD OF THE INVENTION

This invention relates to apparatuses, methods and control systems for the forced convection of seawater.

### BACKGROUND OF THE INVENTION

Hurricanes are giant, spiraling tropical storms that can pack wind speeds of over 160 miles (257 kilometers) an hour and unleash more than 2.4 trillion gallons (9 trillion liters) of rain a day. These same tropical storms are known as cyclones in the northern Indian Ocean and Bay of Bengal, and as typhoons in the western Pacific Ocean. The Atlantic Ocean's hurricane season peaks from mid-August to late October and averages five to six hurricanes per year.

Hurricanes begin as tropical disturbances in warm ocean waters with surface temperatures of at least 80 degrees Fahrenheit (26.5 degrees Celsius). These low pressure systems are fed by energy from the warm surface water of seas. If a storm achieves wind speeds of 38 miles (61 kilometers) an hour, it becomes known as a tropical depression. A tropical depression becomes a tropical storm, and is given a name, when its sustained wind speeds top 39 miles (63 kilometers) an hour. When a storm's sustained wind speeds reach 74 miles (119 kilometers) an hour it becomes a hurricane and earns a category rating of 1 to 5 on the Saffir-Simpson scale.

Hurricanes are enormous heat engines that generate energy on a staggering scale. They draw heat from warm ocean surface water and warm, moist ocean air and release it through condensation of water vapor in thunderstorms.

Hurricanes spin around a low-pressure center known as the “eye.” Sinking air makes this 20- to 30-mile-wide (32- to 48-kilometer-wide) area notoriously calm. But the eye is surrounded by a circular “eye wall” that hosts the storm's strongest winds and rain. These storms bring destruction ashore in many different ways. When a hurricane makes landfall it often produces a devastating storm surge that can reach 20 feet (6 meters) high and extend nearly 100 miles (161 kilometers). Ninety percent of all hurricane deaths result from storm surges.

A hurricane's high winds are also destructive and may spawn tornadoes. Torrential rains cause further damage by spawning floods and landslides, which may occur many miles inland.

A harmful algal bloom (HAB) is an algal bloom that causes negative impacts to other organisms via production of natural toxins, mechanical damage to other organisms, or by other means. HABs are often associated with large-scale marine mortality events and have been associated with various types of shellfish poisonings. In the marine environment, single-celled, microscopic, plant-like organisms naturally occur in the well-lit surface layer of any body of water. These organisms, referred to as phytoplankton or microalgae, form the base of the food web upon which nearly all other marine organisms depend. Of the 5000+ species of marine phytoplankton that exist worldwide, about 2% are known to be harmful or toxic. Blooms of harmful algae can have large and varied impacts on marine ecosystems, depending on the species involved, the environment where they are found, and the mechanism by which they exert negative effects. Examples of common harmful effects of HABs include: the production of neurotoxins which cause mass mortalities in fish, seabirds and marine mammals; human illness or death via consumption of seafood contaminated by toxic algae; mechanical damage to other organisms, such as disruption of epithelial gill tissues in fish, resulting in asphyxiation; and oxygen depletion of the water column (hypoxia or anoxia) from cellular respiration and bacterial degradation. Due to their negative economic and health impacts, HABs are often carefully monitored.

El Niño-Southern Oscillation is a periodic change in the atmosphere and ocean of the tropical Pacific region. It is defined in the atmosphere by the sign of the pressure difference between Tahiti and Darwin, Australia, and in the ocean by warming or cooling of surface waters of the tropical central and eastern Pacific Ocean. El Niño is the warm phase of the oscillation and La Niña is the cold phase. The oscillation does not have a specific period, but occurs every three to eight years. Effects on weather vary with each event, but El Niño and La Niña are associated with floods, droughts and other weather disturbances in many regions of the world. Developing countries dependent upon agriculture and fishing, particularly bordering the Pacific Ocean, are especially affected.

### SUMMARY OF THE INVENTION

Apparatuses, methods and control systems for the forced convection of seawater are provided by the present invention. Through the forcible convection of seawater, the present invention reduces the temperature of warm surface ocean water, thereby reducing the amount of thermal energy available to a tropical storm to draw energy from. Consequently, by reducing the temperature of ocean surface waters, the present invention reduces the strength and occurrence of tropical storms, hurricanes, cyclones, typhoons and the like. The terms tropical storms, hurricanes, cyclones and typhoons are used interchangeably as well as sea and ocean.

The present invention reduces the temperature of ocean surface waters through one of two forced convection methods. The present invention can pump cold water to the surface of the ocean to cool the ocean surface temperature and reduce the energy provided to hurricanes, thereby reducing the strength and occurrence of hurricanes. Alternatively, the present invention can pump warm water from the surface of the ocean to colder lower ocean layers to cool the ocean surface temperature and reduce the energy provided to hurricanes, thereby also reducing the strength and occurrence of hurricanes.

The present invention includes an apparatus for the forced convection of sea water. The apparatus includes a seabed anchor and a helical screw rotatably connected to the seabed anchor. The helical screw is configured to be positioned vertically with respect to the ocean floor. The apparatus further includes a flotation device connected to the helical screw. The flotation device is configured to lift a top portion of the helical screw into a proximal position of a top surface water layer of an ocean. The apparatus further includes a motor coupled to the helical screw. The motor is configured to rotate the helical screw. Rotating the helical screw in a first direction will cause the helical screw to pump warm surface water from the top surface water layer down to a colder subsurface water layer, thereby cooling the temperature of the top surface layer. Rotating the helical screw in a second direction will cause the helical screw to pump cold water from the colder subsurface water layer up to the top surface water layer, thereby cooling the temperature of the top surface water layer.

The present invention also includes an apparatus for the forced convection of sea water. The apparatus includes a seabed anchor and a tube having sidewalls that comprise microbubbles to provide buoyancy to the tube. The tube is connected to the seabed anchor. The tube is configured to be vertically oriented with respect to an ocean floor. A top portion of the tube is configured to be placed adjacent to a top surface water layer of an ocean. The apparatus further includes a helical screw rotatably positioned within the tube and a motor coupled to the helical screw. The motor is configured to rotate the helical screw. Rotating the helical screw in a first direction will cause the helical screw to pump warm surface water from the top surface water layer down to a colder subsurface water layer, thereby cooling the temperature of the top surface layer. Rotating the helical screw in a second direction will cause the helical screw to pump cold water from the colder subsurface water layer up to the top surface water layer, thereby cooling the temperature of the top surface water layer.

The present invention also includes a method for cooling a temperature of a surface layer of ocean water. The method includes rotatably securing a helical screw to an ocean floor, vertically orienting the helical anchor with respect to the ocean floor, raising a top portion of the helical anchor into a proximal position of a top surface water layer of an ocean with a floatation device, and rotating the helical anchor with a motor to pump water between the top surface water layer and a cooler subsurface water layer.

In addition to addressing the strength and occurrence of tropical storms, forcible convection of sea water between upper warm layers and lower cold layers can provide further benefits. By forcibly mixing the sea water, the present invention can address problems caused by algal blooms, more commonly known as red tides, El Niño-Southern Oscillation (the periodic change in the atmosphere and ocean of the equatorial Pacific region), and other undesirable ocean surface phenomena by mixing the cold subsurface water with warm surface water. For example, by mixing cold subsurface water with warm surface water, the present invention can redistribute oxygen levels within the ocean layers counter-acting an algal bloom. In addition, with El Niño, warm surface water swells along the coast of South America and pushes down cold water to deeper depths, thereby altering weather patterns and negatively impacting sealife. By forcibly convecting the warm surface waters with colder water from deeper layers, the present invention can counteract the El Niño effect, as well as La Niña which is the reverse of El Niño with cold surface water overlying warm subsurface water.

Further aspects of the invention will become apparent as the following description proceeds and the features of novelty which characterize this invention are pointed out with particularity in the claims annexed to and forming a part of this specification.

### BRIEF DESCRIPTION OF THE DRAWINGS

The novel features that are considered characteristic of the invention are set forth with particularity in the appended claims. The invention itself; however, both as to its structure and operation together with the additional objects and advantages thereof are best understood through the following description of the preferred embodiment of the present invention when read in conjunction with the accompanying drawings.

FIG. 1 is a top view of a forced convection assembly.

FIG. 2 is a cutaway side view of a rotating tube and rotating helical screw.

FIG. 3 is a cutaway side view of a stationary tube and rotating helical screw.

FIG. 4 is a block diagram of rotation control circuitry.

FIG. 5 illustrates a side view of a forced convection assembly floating in an ocean and mounted to a sea floor pumping water from a subsurface water layer to a top surface water layer.

FIG. 6 illustrates a side view of a forced convection assembly floating in an ocean and mounted to a sea floor pumping water from a top surface water layer to a subsurface water layer.

FIG. 7 is a side view of a first embodiment of a forced convention assembly having a wind powered motor.

FIG. 8 is a side view of a second embodiment of a forced convection assembly having an ocean current powered motor.

FIG. 9 depicts a map showing a placement of an array of forced convection assemblies in the path of a hurricane.

FIG. 10 depicts a flowchart illustrating a method for cooling the temperature of a top surface water layer of an ocean.

FIG. 11 depicts a flow chart illustrating a method for controlling the operation of a forced convection assembly.

### DETAILED DESCRIPTION OF THE INVENTION

This invention is described in preferred embodiments in the following description with reference to the Figures, in which like numbers represent the same or similar elements. While this invention is described in terms of the best mode for achieving this invention's objectives, it will be appreciated by those skilled in the art that variations may be accomplished in view of these teachings without deviating from the spirit or scope of the invention.

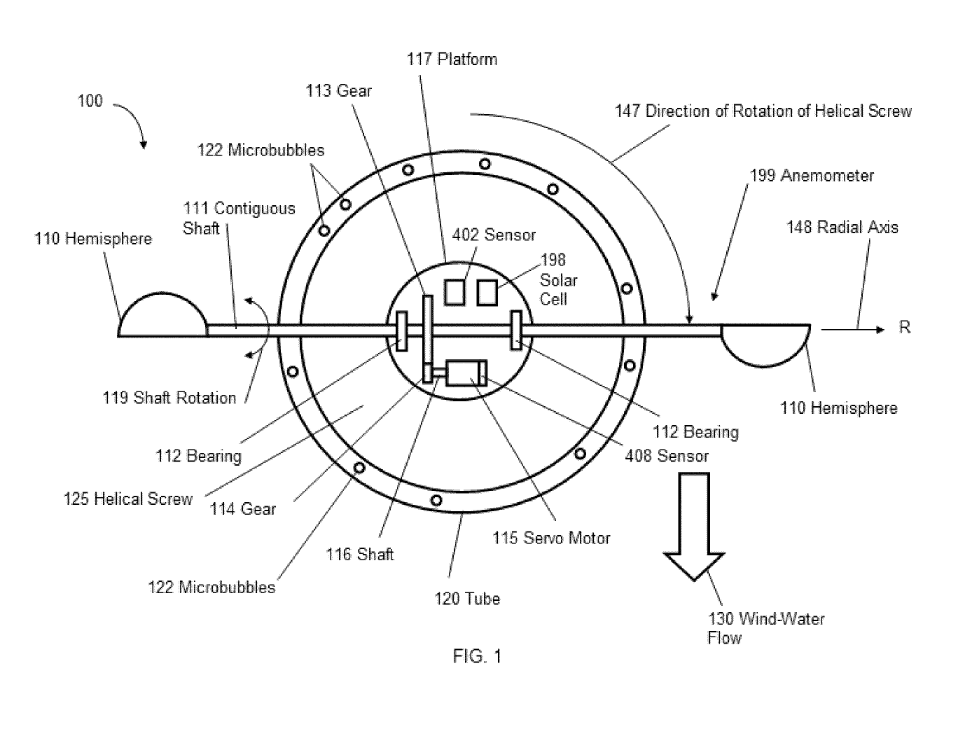

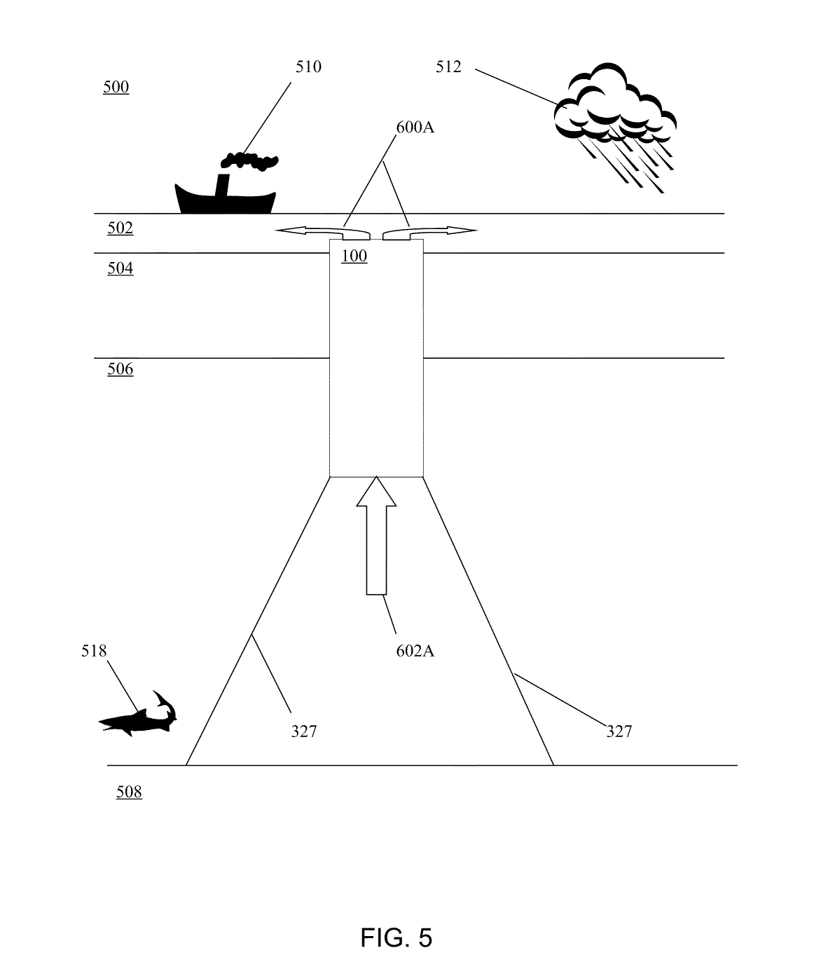

FIGS. 1, 2 and 3, illustrate an example of a forced convection apparatus 100. Forced convention apparatus 100 includes a helical screw 125 that may be positioned within a tube 120. Tube 120 is anchored to an ocean or sea floor with a seabed anchor 227 or 327. In this written description, the use of words “ocean” and “sea” are used interchangeably and are not meant to have any limiting effect and are merely used to describe a large body of water. The helical screw 125 rotates with respect to seabed anchors 227 or 327. A top portion of tube 120 is placed in or near a top surface water layer 502 (shown in FIGS. 5-8) of an ocean or sea. The helical screw 125 is rotated to pump water between the top surface water layer 502 and a lower subsurface water layer 506 (shown in FIGS. 5-8). The top surface water layer 502 is warmer in temperature than the lower subsurface water layer 506. By pumping water between the warmer top surface water layer 502 and the lower subsurface water layer 506, apparatus 100 is able to lower the temperature of the top surface water layer 502. By lowering the temperature of the top surface water layer 502, apparatus 100 reduces the amount of thermal energy available to tropical storms or hurricanes, thereby reducing the strength and occurrence of tropical storms and hurricanes. In addition, by mixing cold subsurface water with warm surface water, the present invention can redistribute oxygen levels within the ocean layers counter-acting an algal bloom. Further, with El Niño, warm surface water swells along the coast of South America and pushes down cold water to deeper depths, thereby altering weather patterns and negatively impacting sealife. By forcibly convecting the warm surface waters with colder water from deeper layers, the present invention can counteract the El Niño effect, as well as La Niña which is the reverse of El Niño with cold surface water overlying warm subsurface water.

The rotation of helical screw 125 is powered by a motor formed of an anemometer 199. Anemometer 199 may be configured to be powered by the wind. Alternatively, anemometer 199 may be configured to be powered by the flow of ocean current.

FIGS. 1, 2 and 3 illustrate an exemplary anemometer 199 that is formed of a pair of hemispheres 110. This pair of hemispheres 110 is mounted on opposing ends of contiguous shaft 111. Each pair of hemispheres 110 is geometrically identical; however, each pair of hemispheres 110 is mounted in the same direction along direction 147 of rotation of helical screw 125. In a preferred embodiment, anemometer 199 is formed of two or more hemispheres 110. In an alternate embodiment, hemispheres 110 are replaced by cones, frustums, pyramids, or other geometric shapes. Anemometer 199 may also be formed of a water-configured propeller or an air-configured propeller that is coupled with a vane or rudder to maintain the direction of the propeller with respect to the flow of air or water.

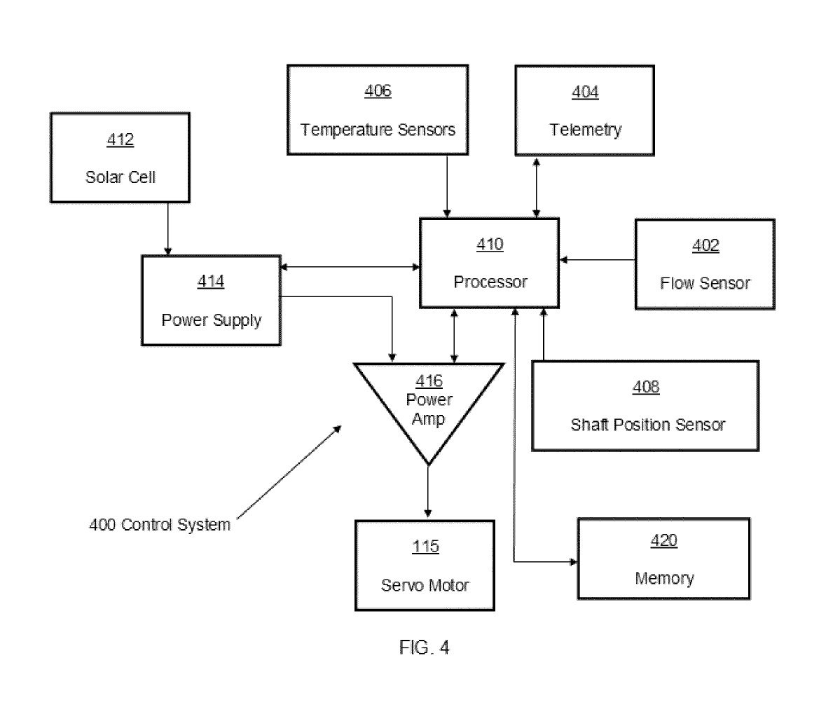

Anemometer 199 may include a servo motor 115. Servo motor 115 controls the angle of engagement of hemispheres 110 with respect to the direction of water or air flow. Servo motor 115 controls the rotation 119 of contiguous shaft 111 about radial axis R 148. For example, in FIGS. 1, 2 and 3, hemispheres 110 are shown rotated in a 90 degree orientation where they fully engage the flow of air or water. Servo motor 115 can pivot hemispheres 110 to any angle with respect to the flow of air or water such as 0 degrees, 30 degrees, 45, degrees, or 60 degrees, for example. At 0 degrees orientation, the hemispheres do not engage the flow of air or water, thereby preventing anemometer 199 from rotating helical screw 125. At less than 90 degrees rotation, servo motor 115 prevents the hemispheres 110 from fully engaging the flow of air or water thereby reducing the amount of force applied to helical screw 125 by anemometer 199. The associated control circuitry 400 for servo 115 is shown in FIG. 4.

Servo motor 115 rotates gear 114 attached to the shaft 116 of servo motor 115. The amount of rotation of servo motor 115 and hence gear 114 is measured via rotation sensor 408. Rotation sensor 408 can be a rotational encoder, a rotary potentiometer, a rotational capacitor, or a rotary variable differential transformer. Gear 114 rotates gear 113 which is co-axially mounted to contiguous shaft 111. Bearings 112 support contiguous shaft 111, and permit the rotation 119 of shaft 111 about radial axis R 148. Examples of bearings 112 include ball bearings and roller bearings. In an alternate embodiment, bearings 112 are replaced by bushings. In yet another alternate embodiment, markings on gear 113 which are optically or magnetically detected comprise rotational position information regarding contiguous shaft 111. While shown having a pair of hemispheres 110 mounted on a single shaft 111, it is contemplated that anemometer 199 may include more than two hemispheres 110 mounted on more than one shaft 111. Gearing apparatuses for controlling the rotation and angle of engagement of anemometers having more than two hemispheres 110 mounted on one or more shafts 111 are well known and exist in many varieties.

Each of bearing 112 is attached to a bearing support block 131, which is in turn attached to platform 117. Vertical shaft 126 is also attached to platform 117. As wind or water flow 130 interacts with hemispheres 110 cause contiguous shaft 111 to spin about vertical axis 149, vertical shaft 126 correspondingly rotates, which causes helical screw 125 to rotate and cause forced convection of seawater by pumping seawater between the two open ends of tube 120. Platform 117 is mounted to helical screw 125. When the flow of air or water engages hemispheres 110, anemometer 199 rotates, thereby causing helical screw 125 to rotate and pump water between the top surface water layer 502 and the subsurface water layer 506.

Also mounted on platform 117 are wind or water flow sensors 402 and solar cell 198. Wind or water flow sensors 402 provide a direct measurement of overall wind speed or water current flow rate and the speed of wind gusts or wave surges for servo motor 115. Solar cell 198 provides electrical power for servo motor 115. Servo motor 115 controls the direction of rotation of helical screw 125 by controlling the angle of engagement of hemispheres 110. Servo motor 115 is shown in FIGS. 1, 2 and 3 to have positioned hemispheres 110 to an angle whereby air flow or water flow would cause anemometer 199 and helical screw 125 to rotate in a clockwise manner about vertical axis 149. Using servo motor 115 to rotate hemispheres 110 180 degrees would cause anemometer 199 and helical screw 125 to rotate counter-clockwise about vertical axis 149 in relation to the same air or water flow.

Tube 120 provides a conduit for seawater drawn up or drawn down by helical screw 125, depending upon the orientation of hemispheres 110. Tube 120 is illustrated as comprising a right circular cylinder with each end open. However, tube 120 may include various contours and curved surfaces at the openings at each end and in the middle between the two ends to enhance the intake of water into tube 120, enhance the transport of water within tube 120, and enhance the expulsion of water from tube 120. For example, tube 120 may include fluted ends to enhance the intake and outflow of water. The materials used to manufacture the wall of tube 120 include acrylic, polycarbonate, delrin, aluminum, titanium, and stainless steel. In an alternate embodiment, microballoons 122 are used to reduce the density of acrylic, polycarbonate, and delrin. These microballoons 122 are hollow spheres, commonly made of glass, which create voids and thus reduce the mass density of materials. Microballoons 122, also referred to as microbubbles, provide buoyancy to tube 120. Tube 120 may also be formed of a material that inherently includes inclusions that are filled with a lighter than water material, which thereby provides buoyancy. Further, tube 120 may be made of a material that is itself inherently buoyant.

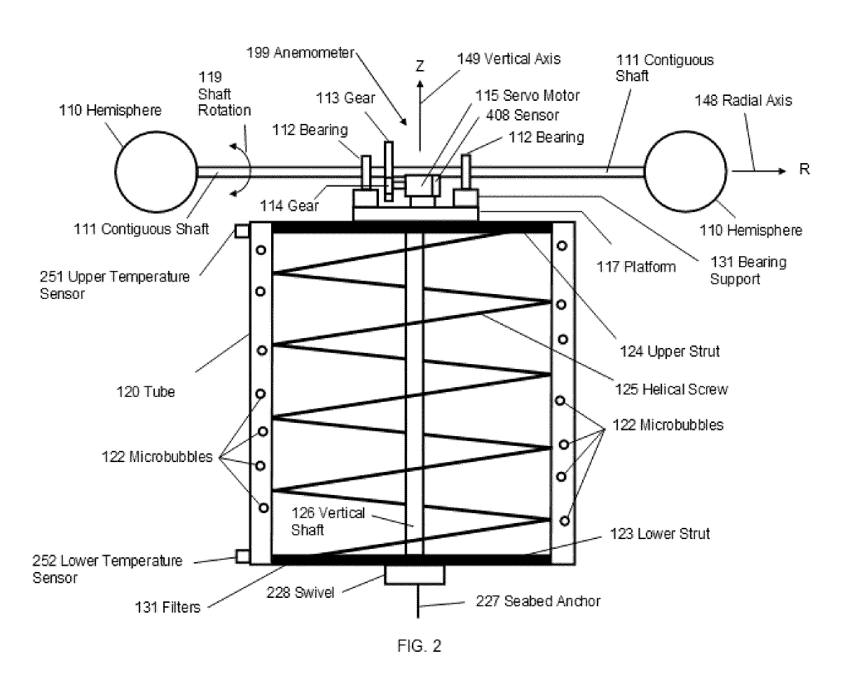

In FIG. 2, upper strut 124 connects tube 120, vertical shaft 126, and platform 117, and lower strut 123 connects tube 120 and vertical shaft 126.

Lower strut 123 has a dual role, that of ballast, to help keep assembly 100 vertical in the water. Swivel 228 is attached to both seabed anchor 227 and lower strut 123, so that assembly 100 may rotate freely without twisting sea anchor 227.

Tube 120 has an upper temperature sensor 251 and lower temperature sensor 252, so that the temperature differential between surface seawater 502 and deeper seawater 506 can be calculated by processor 410 with the control circuit 400, shown in FIG. 4. It is this temperature differential which determines the cooling effect of drawing cold water up from ocean depths, or drawing hotter sea water off of the surface 502 of the sea and pushing the hotter sea water into the depths of the ocean 506. In FIG. 2, tube 120 may rotate along with helical screw 125. In the embodiment shown in FIG. 2, tube 120 and helical screw 125 may be fixed to each other such that they do not rotate with respect to each other.

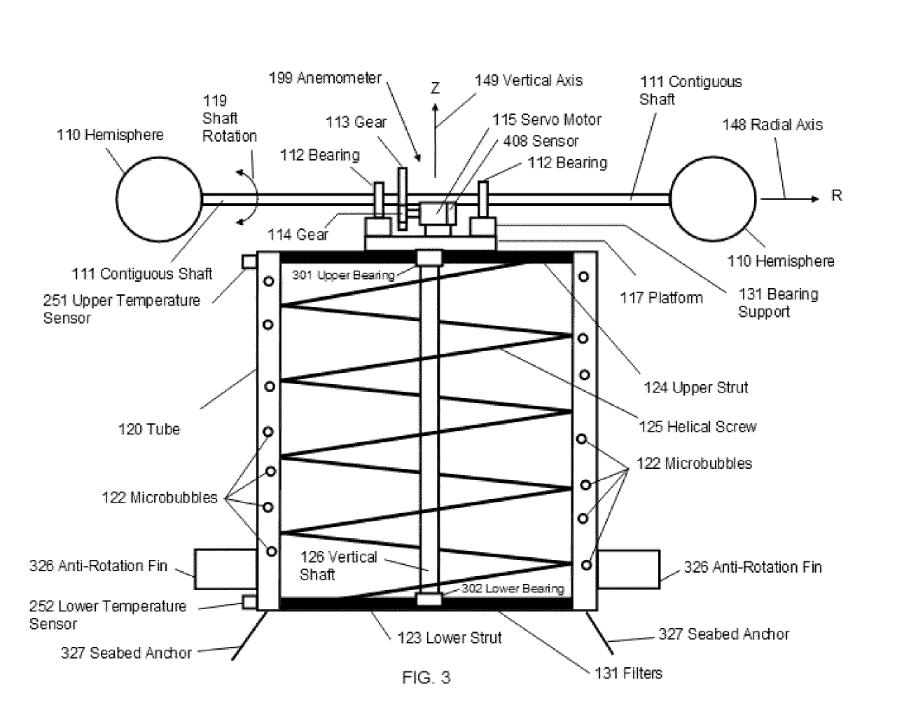

FIG. 3 shows a stationary tube 120, where upper bearing 301 and lower bearing 302 are used to permit vertical shaft 126 and helical screw 125 to rotate about vertical axis Z 149. One or more anti-rotation fins 326 on the outside of tube 120 are used to keep tube 120 from rotating about vertical axis 149. Additionally, two or more sea anchors 327 are attached to tube 120 to prevent the rotation of tube 120. In an alternate embodiment, sea anchors 327 are attached to lower strut 123, which is then attached to tube 120.

FIG. 4 shows control circuitry 400. Air and current flow sensor 402 provides the speed of wind or water current flow 130 information to processor 410. Temperature sensors 251 and 252 provide the temperature information of surface sea water and deeper sea water, respectively, so that the differential temperature can be calculated by processor 410. Processor 410 can receive commands and information from telemetry 404 and send information such as temperature differential, wind or water current speed, etc. Solar cell 198, or another power source such as a battery or anemometer 199 or another anemometer, provides power to power supply 414, which in turns powers processor 410 and power amplifier 416. Processor 410 controls servo motor 115 by controlling the electrical power sent to servo motor 115 by power amp 416. Shaft position sensor 408 provides processor 410 with the angle information regarding hemispheres 110. Control circuit 400 is configured to control the rotation of shaft 111 based upon received information. Control circuit 400 is configured to control the direction and rate of rotation of helical screw 125 based upon received information.

As shown in FIGS. 1, 2, and 3, wind or water flow 130 causes helical screw 125 to rotate in axis 149, which causes colder sea water to be drawn into the open lower end of tube 120 and exited out the open upper end of tube 120. One example of the control provided by processor 410 is to rotate contiguous shaft 111 one-half turn (one hundred and eighty degrees) about radial axis R 148 so that the direction of rotation of helical screw 125 is reversed from that shown in FIGS. 1, 2, and 3, thus drawing hotter sea water into the open upper end of tube 120 and exiting the open lower end of tube 120.

Yet another example of the control provided by processor 410 is to rotate contiguous shaft 111 one-quarter turn (ninety degrees) about radial axis R 148 so that there is no rotation of helical screw 125, such as when there is no temperature differential between temperature sensors 251 and 252.

Yet another example of control provided by processor 410 is to rotate contiguous shaft 111 an angle ranging between zero degrees and one-hundred and eighty degrees about radial axis R 148, to control both the direction and speed of rotation of helical screw 125. For example, rotating contiguous shaft 111 an angle of one-eighth turn (forty-five degrees) about radial axis R 148 reduces the speed of rotation of helical screw 125 versus the orientation of contiguous shaft 111 shown in FIGS. 1, 2, and 3. Such a one-eighth turn of contiguous shaft 111 about radial axis R 148 would be valuable if excessive wind gusts or ocean current surges exist, as measured by flow sensor 402.

The instructions executed by processor 410 are stored in memory 420. Processor 410 may update memory 420 with new instructions received by telemetry 404. Additionally, processor 410 can transmit the status of actions it executes to a home station via telemetry 404. Telemetry 404 may be sent through radio or satellite signals.

The implementations may involve software, firmware, micro-code, hardware and/or any combination thereof. The implementation may take the form of code or logic implemented in a medium, such as processor 410 or memory 420 where the medium may comprise hardware logic (e.g. an integrated circuit chip, Programmable Gate Array [PGA], Application Specific Integrated Circuit [ASIC], or other circuit, logic or device), or a computer readable storage medium, such as a magnetic storage medium such as an electronic, magnetic, optical, electromagnetic, infrared, or semiconductor system, semiconductor or solid state memory, magnetic tape, a removable computer diskette, and random access memory [RAM], a read-only memory [ROM], a rigid magnetic disk and an optical disk such as compact disk-read only memory [CD-ROM], compact disk-read/write [CD-R/W], digital versatile disk [DVD], and Blu-Ray disk [BD].

FIG. 5 illustrates a side view of a forced convection assembly 100 floating in an ocean and mounted to sea floor 508 pumping water from a subsurface water 506 layer to a top surface water layer 502. Forced convection assembly 100 is mounted to the seafloor 508 with seabed anchors 327. Cold seawater is pumped in from layer 506 and ejected into warm surface layer 502, as shown by arrows 600A and 602A. By pumping colder seawater from layer 506 up to surface water layer 502, forced convection assembly 100 lowers the temperature of surface water layer 502. By reducing the temperature of surface water layer 502, forced convection assembly 100 reduces the amount of thermal energy available to tropical storm or hurricane 512. A surface ship 510 is shown floating on the surface of the ocean and a shark 518 is shown near ocean floor 508 merely for illustrative purposes regarding the ocean environment. Layer 504 is a water layer having an intermediate temperature between that of layers 502 and 506.

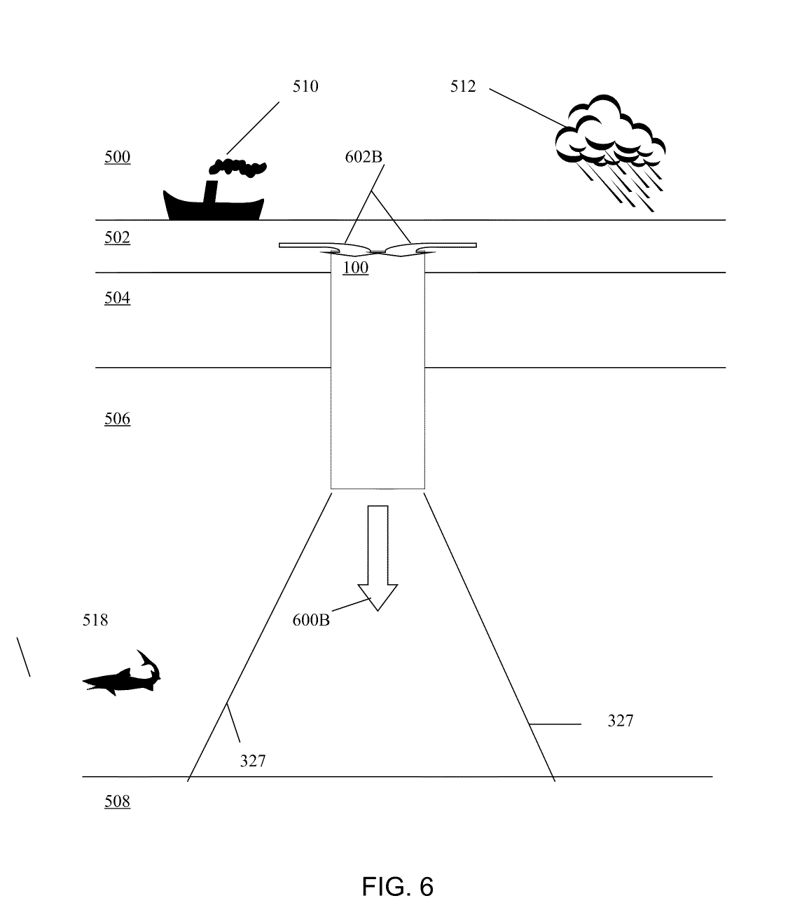

FIG. 6 illustrates a side view of a forced convection assembly 100 floating in an ocean and mounted to sea floor 508 pumping water from a top warm surface water layer 502 to a colder subsurface water layer 506. By pumping warm surface water in layer 502, as shown by arrows 600B and 602B, down to colder subsurface water layer 506, forced convection assembly 100 reduces the temperature of layer 502, thereby reducing the thermal energy available to tropical storm or hurricane 512. Forced convection assembly 100 may include filters 131 contained within tube 120 that are capable of filtering oil from seawater or fresh water. Consequently, in the event of an oil spill on top surface water layer 502, forced convection assembly 100 could pump the oil infused water down through assembly 100 through filters 131 contained within assembly 100 to filter out the oil from the seawater.

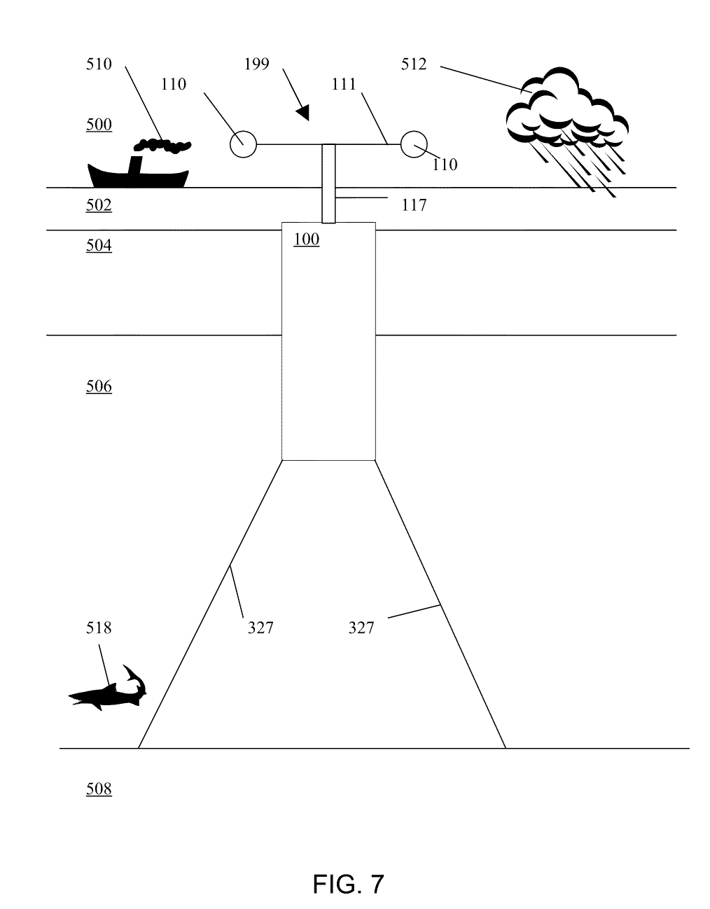

FIG. 7 is a side view of a first embodiment of a forced convention assembly 100 having a wind powered motor 199. As discussed above, the rotation of helical screw 125 may be powered by a wind driven anemometer 199, as shown in FIG. 7. Anemometer 199 includes hemispherical cups 110 mounted on shaft 111 that is coupled to helical screw 125 by platform 117. Note that wind driven anemometer 199 extends above the surface of the top ocean surface layer 502 in order to interact with the wind 130. A top portion of forced convection assembly 100 extends into the top surface water layer 502 while a bottom portion of assembly 100 extends down into a colder subsurface water layer 506.

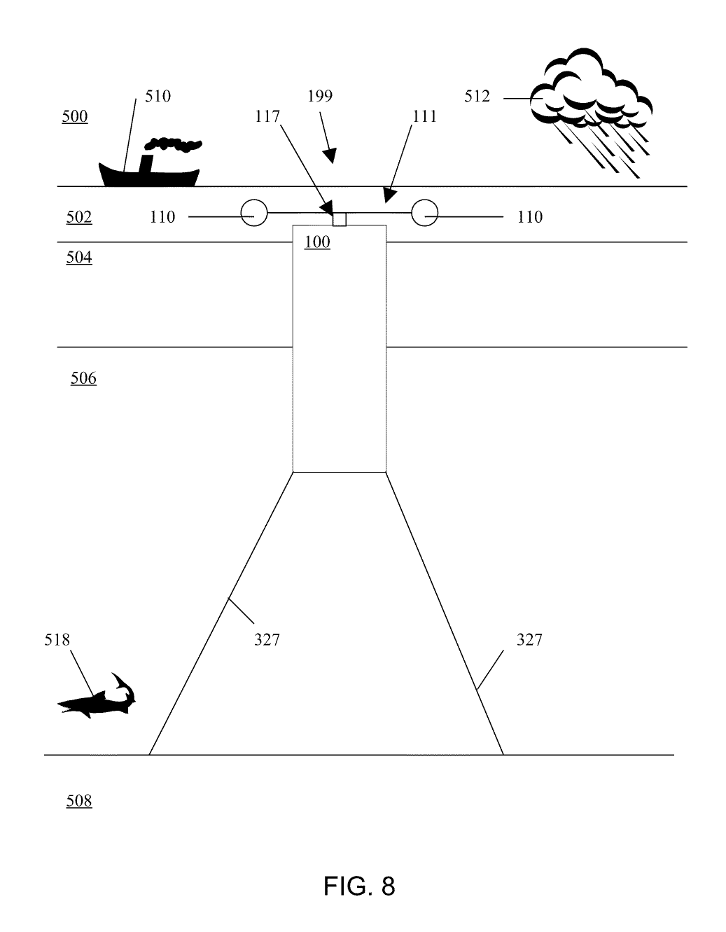

FIG. 8 is a side view of a second embodiment of a forced convention assembly 100 having an ocean current powered motor 199. As discussed above, the rotation of helical screw 125 may be powered by an ocean-current driven anemometer 199, as shown in FIG. 8. Anemometer 199 includes hemispherical cups 110 mounted on shaft 111 that is coupled to helical screw 125 by platform 117. Note that ocean-current driven anemometer 199 is submerged below the surface of the top ocean surface layer 502 in order to interact with the ocean current. A top portion of forced convection assembly 100 extends into the top surface water layer 502 while a bottom portion of assembly 100 extends down into a colder subsurface water layer 506.

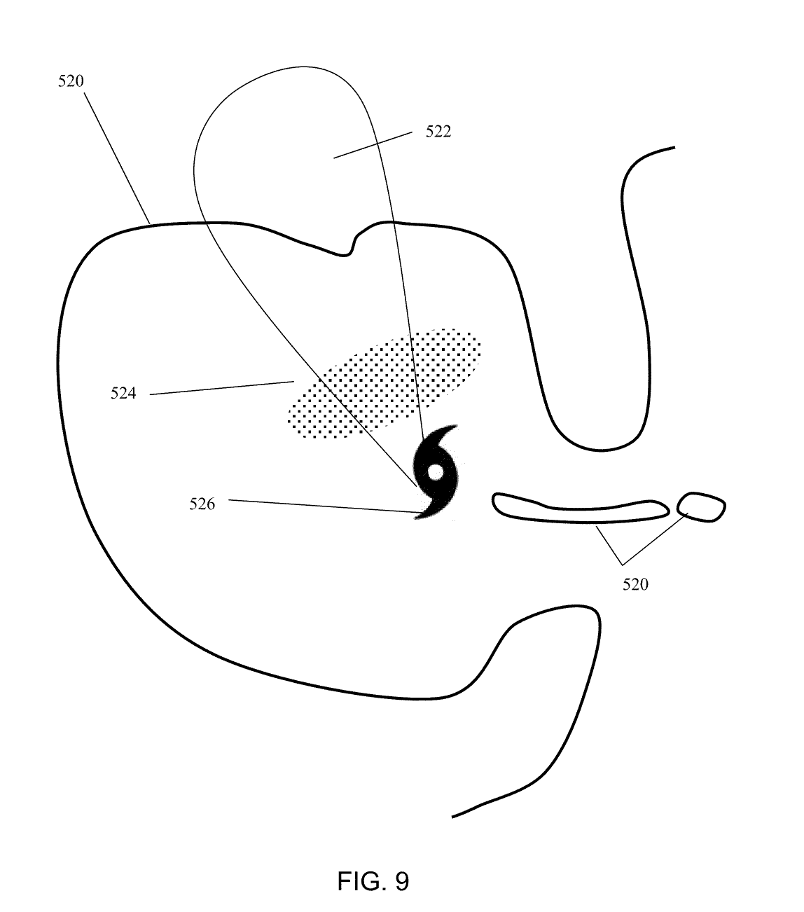

FIG. 9 depicts a map 520 showing a placement of an array 524 of forced convection assemblies 100 in the path 522 of a hurricane 526. Map 520 depicts the Gulf of Mexico including the shoreline of Florida, Alabama, Mississippi, Louisiana, Texas and Mexico with the Yucatan Peninsula jutting out toward Cuba and Puerto Rico. A projected path 522 of Hurricane 526 shows that it is heading towards Louisiana. An array 524 of forced convection assemblies 100 is placed in the projected path 522 of hurricane 526. This array 524 of forced convection assemblies 100 acts in combination to reduce the temperature of the top surface layer of water 502 in order to reduce the thermal energy available to hurricane 526, thereby reducing the strength of hurricane 526. Array 524 is shown as an oval shaped series of dots, where each dot may for example represent a single forced convection assembly 100.

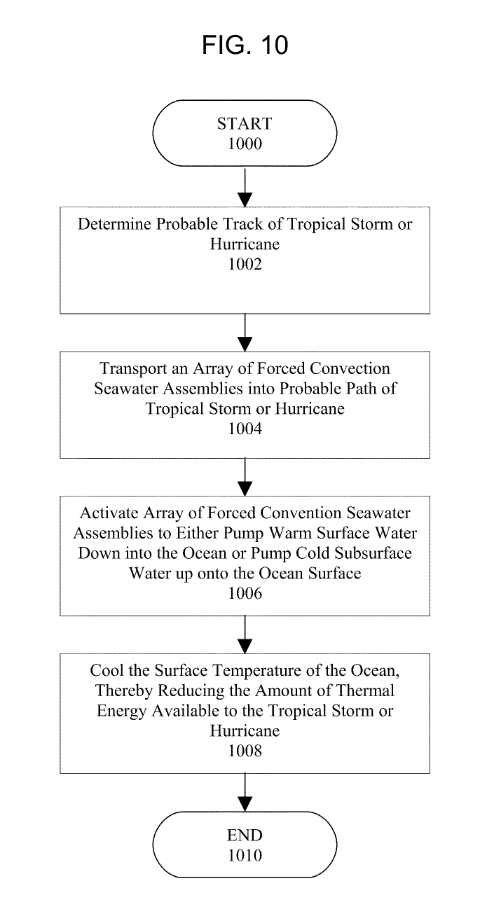

FIG. 10 depicts a flowchart illustrating a method for cooling the temperature of a top surface water layer of an ocean. The process begins with START 1000. In step 1002, the probable track 522 of a tropical storm 526 or hurricane is determined. Note that the terms tropical storm, hurricane, cyclone and typhoon are used interchangeably in a non-limiting manner within this specification. In step 1004, an array 524 of forced convection assemblies is transported into the probable path 522 of hurricane 526. In step 1006, the array 524 of forced convection assemblies 100 is activated to either pump cold water up from a lower subsurface layer 506 to the warmer top surface layer 502, or pump warm water from the top surface layer 502 down toward the lower subsurface layer 506. By pumping water between layers 502 and 506, forced convection assembly 100 is able to reduce the temperature of top surface water layer 502 in step 1008, thereby reducing the amount of thermal energy available to hurricane 526, consequently reducing its strength. The process ENDS in step 1010.

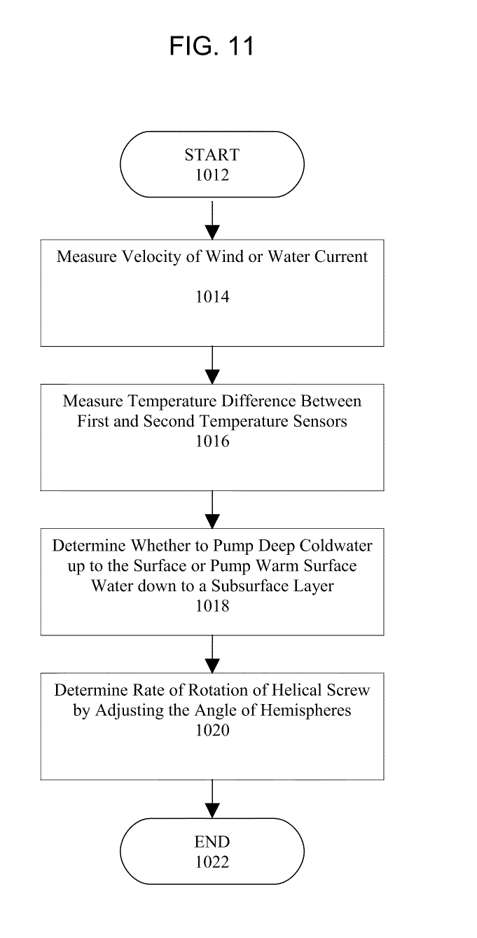

FIG. 11 depicts a flow chart illustrating a method for controlling the operation of a forced convection assembly 100. The method begins with START 1012. In step 1014, the control circuit 400 uses flow sensor 402 to measure the wind or ocean current velocity. In step 1016, the control circuit 400 measures the temperature difference between upper and lower temperature sensors 251 and 252. Using the wind or current velocity information and the temperature difference information, the control circuit 400 determines whether to pump cold water up from layer 506 to layer 502, or to pump warm water down from layer 502 to layer 506 in step 1018. In addition, the control circuit determines at what rate helical screw 125 should be rotated by angling the hemispheres 110 with respect to the flow of air or water with servo motor 115 in step 1020. The method ENDS in step 1022.

While the preferred embodiments of the present invention have been illustrated in detail, it should be apparent that modifications and adaptations to those embodiments may occur to one skilled in the art without departing from the scope of the present invention as set forth in the following claims.

What is claimed is:

1. An apparatus for the forced convection of sea water, said apparatus comprising:
a seabed anchor;
a helical screw rotatably connected to the seabed anchor, the helical screw configured to be positioned vertically with respect to the ocean floor;
a flotation device connected to the helical screw, wherein the flotation device is configured to lift a top portion of the helical screw into a proximal position of a top surface water layer of an ocean; and
a motor coupled to the helical screw, the motor being configured to rotate the helical screw, wherein rotating the helical screw in a first direction will cause the helical screw to pump warm surface water from the top surface water layer down to a colder subsurface water layer, thereby cooling the temperature of the top surface layer, wherein rotating the helical screw in a second direction will cause the helical screw to pump cold water from the colder subsurface water layer up to the top surface water layer, thereby cooling the temperature of the top surface water layer.

2. The apparatus of claim 1, wherein the motor is powered by an ocean current.

3. The apparatus of claim 2, wherein the motor is comprised of a submerged anemometer.

4. The apparatus of claim 1, wherein the motor is powered by wind.

5. The apparatus of claim 4, wherein the motor comprises an anemometer mounted above an ocean surface.

6. The apparatus of claim 1, wherein the flotation device comprises a tube, wherein the helical screw is positioned within the tube.

7. The apparatus of claim 6, wherein the tube includes sidewalls that contain microbubbles to provide buoyancy to the tube.

8. The apparatus of claim 6, wherein a longitudinal axis of the tube is coaxially aligned with a longitudinal axis of the helical screw.

9. The apparatus of claim 1, further comprising a control system configured to control the operation of the motor that causes the helical screw to pump cold water up toward the ocean surface or pump warm surface water down to the colder subsurface layer.

10. The apparatus of claim 9, further comprising an upper temperature sensor and a lower temperature sensor each coupled to the control system, wherein the upper temperature sensor is mounted near a top portion of the tube, wherein the lower temperature sensor is mounted near a lower portion of the tube.

11. A method for cooling a temperature of a surface layer of ocean water, the method comprising:
rotatably securing a helical screw to an ocean floor;
vertically orienting the helical anchor with respect to the ocean floor;
raising a top portion of the helical anchor into a proximal position of a top surface water layer of an ocean with a floatation device; and
rotating the helical anchor with a motor to pump water between the top surface water layer and a cooler subsurface water layer.

12. The method of claim 11, wherein the floatation device comprises a tube having a sidewall filled with microbubbles that provide buoyancy to the tube, wherein the helical screw is rotatably mounted within the tube, wherein a longitudinal axis of the tube is coaxially aligned with a longitudinal axis of the helical screw.

13. The method of claim 11, further comprising powering the motor with an ocean current.

14. The method of claim 11, further comprising powering the motor with wind.

15. The method of claim 12, further comprising controlling the rate of rotation of the helical screw with a control system based upon temperature information acquired from a pair of temperature sensors mounted to a top portion and a bottom portion of the tube.

16. An apparatus for the forced convection of sea water, said apparatus comprising:
a seabed anchor;
a tube having sidewalls that comprise microbubbles to provide buoyancy to the tube, the tube being connected to the seabed anchor, the tube being configured to be vertically oriented with respect to an ocean floor, a top portion of the tube being configured to be placed adjacent to a top surface water layer of an ocean;
a helical screw positioned within the tube, the helical screw being rotatable relative to the seabed anchor; and
a motor coupled to the helical screw, the motor being configured to rotate the helical screw, wherein rotating the helical screw in a first direction will cause the helical screw to pump warm surface water from the top surface water layer down to a colder subsurface water layer, thereby cooling the temperature of the top surface layer, wherein rotating the helical screw in a second direction will cause the helical screw to pump cold water from the colder subsurface water layer up to the top surface water layer, thereby cooling the temperature of the top surface water layer.

17. The apparatus of claim 16, wherein the motor is powered by water current.

18. The apparatus of claim 16, wherein the motor is powered by wind.

19. The apparatus of claim 17, wherein the motor comprises a submerged anemometer.

20. The apparatus of claim 18, wherein the motor comprises an anemometer positioned above an ocean surface.
